(19) United States
(12) Patent Application Publication
(10) Pub. No.: US 2021/0278651 A1
(43) Pub. Date: Sep. 9, 2021

(54) LIGHT SHEET MICROSCOPE

(71) Applicant: LEICA MICROSYSTEMS CMS GMBH, Wetzlar (DE)

(72) Inventors: Werner KNEBEL, Kronau (DE); Florian FAHRBACH, Heidelberg (DE); Christof FRANKE, Dietzhoelztal (DE); Dirk-Oliver FEHRER, Bad Schoenborn (DE)

(73) Assignee: Leica Microsystems CMS GmbH, Wetzlar (DE)

(21) Appl. No.: 17/292,474

(22) PCT Filed: Nov. 12, 2019
(86) PCT No.: PCT/EP2019/081042

§ 371 Date: May 10, 2021

(30) Foreign Application Priority Data
Nov. 12, 2018 (DE) 10 2018 128 264.8

(51) Int. Cl. G02B 21/08; G02B 21/00; G02B 21/04; G02B 21/24

(52) U.S. Cl. CPC G02B 21/088; G02B 21/0032; G02B 21/241; G02B 21/04; G02B 21/006

(57) ABSTRACT

A light sheet microscope includes: a detection objective configured to image a target region of a sample located in a focal plane of the detection objective; an illumination objective configured to focus an illumination light beam in the sample, the detection objective and the illumination objective being opposite to one another, and the optical axis of the detection objective and the optical axis of the illumination objective being parallel to one another; a first light deflection device having at least one first deflection surface and one second deflection surface, which are each arranged offset to the optical axis of the detection objective and are configured to deflect the illumination light beam focused by the illumination objective in a direction perpendicular to the optical axis of the detection objective such that a deflected illumination light beam forms a light-sheet-like illumination light distribution focused in the focal plane.

### CROSS-REFERENCE TO PRIOR APPLICATIONS

This application is a U.S. National Phase application under 35 U.S.C. § 371 of International Application No. PCT/EP2019/081042, filed on Nov. 12, 2019, and claims benefit to German Patent Application No. DE 10 2018 128 264.8, filed on Nov. 12, 2018. The International Application was published in German on May 22, 2020 as WO 2020/099415 under PCT Article 21(2).

### FIELD

The invention relates to a light sheet microscope, having a detection objective for imaging a target region of a sample located in a focal plane of the detection objective, and an illumination objective for focusing an illumination light beam in the sample. The detection objective and the illumination objective are opposite to one another, and the optical axis of the detection objective and the optical axis of the illumination objective are parallel to one another. The light sheet microscope furthermore comprises a first light deflection device having at least one first deflection surface and one second deflection surface, which are each arranged offset to the optical axis of the detection objective and are designed to deflect the illumination light beam focused by the illumination objective in a direction perpendicular to the optical axis of the detection objective in such a way that the deflected illumination light beam forms a light-sheet-like illumination light distribution focused in the focal plane.

### BACKGROUND

Various optical arrangements for implementing a light sheet microscope are known from the prior art. For example, a light sheet microscope is known from DE 10 2011 056 914 A1, in which a light-sheet-like illumination light distribution is focused by an illumination objective and deflected by a light deflection device in a focal plane in a sample which is perpendicular to the optical axis of the illumination objective. This light sheet microscope has the disadvantage that the light deflection device has to be located in the image field of the illumination objective. In the case of two opposing deflection surfaces, which both have to be located in the image field of the illumination field, the size of the sample is thus limited by the image field of the illumination objective. Furthermore, the sample can only be illuminated using a comparatively thick illumination light distribution, which limits the maximum achievable axial resolution.

A light sheet microscope having an illumination objective and a detection objective, which are arranged opposite to one another, is known from DE 10 2012 109 577 A1. A light-sheet-like illumination light distribution is focused by the illumination objective. The illumination light distribution is deflected by one or more light deflection devices in a focal plane. The illumination objective and the detection objective can furthermore be offset from one another, so that the light deflection device can be arranged outside the image field of the illumination objective for illuminating larger samples using a thinner illumination light distribution. However, this light sheet microscope is mechanically complex and is linked to high manufacturing costs. Since it requires extensive changes to the structure of the microscope, it cannot be retrofitted in existing systems.

### SUMMARY

In an embodiment, the present invention provides a light sheet microscope, comprising: a detection objective configured to image a target region of a sample located in a focal plane of the detection objective; an illumination objective configured to focus an illumination light beam in the sample, the detection objective and the illumination objective being opposite to one another, and the optical axis of the detection objective and the optical axis of the illumination objective being parallel to one another; a first light deflection device having at least one first deflection surface and one second deflection surface, which are each arranged offset to the optical axis of the detection objective and are configured to deflect the illumination light beam focused by the illumination objective in a direction perpendicular to the optical axis of the detection objective such that a deflected illumination light beam forms a light-sheet-like illumination light distribution focused in the focal plane; and a second light deflection device configured to deflect the illumination light beam focused by the illumination objective on at least one of the two deflection surfaces of the first light deflection device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic illustration of a light sheet microscope as a first exemplary embodiment;

FIG. 2 shows a further schematic illustration of the light sheet microscope according to FIG. 1;

FIG. 3 shows a schematic illustration of the light sheet microscope having two rhomboid prisms as a second exemplary embodiment;

FIG. 4 shows a schematic illustration of the light sheet microscope having a beam splitter element as a third exemplary embodiment;

FIG. 5 shows a schematic illustration of an inverse light sheet microscope as a fourth exemplary embodiment;

FIG. 6 shows a schematic illustration of the inverse light sheet microscope as a fifth exemplary embodiment; and

FIG. 7 shows a schematic illustration of a light sheet microscope according to the prior art.

### DETAILED DESCRIPTION

In an embodiment, the present invention provides a light sheet microscope which permits larger samples to be imaged with an improved axial resolution over conventional light sheet microscopes and at the same time is mechanically simple and inexpensive to produce and can be retrofitted.

The light sheet microscope according to the invention comprises a detection objective for imaging a target region of a sample located in a focal plane of the detection objective, and an illumination objective for focusing an illumination light beam in the sample. The detection objective and the illumination objective are opposite to one another and the optical axis of the detection objective and the optical axis of the illumination objective are parallel to one another. The light sheet microscope furthermore comprises a first light deflection device having at least one first deflection surface and one second deflection surface, which are each arranged offset to the optical axis of the detection objective and are designed to deflect the illumination light beam focused by the illumination objective in a direction perpendicular to the optical axis of the detection objective in such a way that the deflected illumination light beam forms a light-sheet-like illumination light distribution focused in the focal plane, and a second light deflection device which is designed to offset the illumination light beam focused by the illumination objective parallel to the optical axis of the illumination objective and deflect it onto at least one of the two deflection surfaces of the first light deflection device.

The invention provides offsetting the illumination light beam focused by the illumination objective in parallel to the optical axis of the illumination objective by the second light deflection device. This permits the two deflection surfaces of the first light deflection device to be arranged outside the image field of the illumination objective. In this way, it is possible in a particularly mechanically simple manner to illuminate larger samples than in previously known light sheet microscopes. Furthermore, an illumination objective having a larger numerical aperture can also be selected without limiting the size of the sample at the same time. In this way, a thinner light sheet can be generated than in previously known light sheet microscopes and therefore an improved axial resolution can be achieved. A further advantage of the invention is that the two light deflection devices can be retrofitted easily on already existing light sheet microscopes.

The optical axis of the detection objective is preferably arranged between the first deflection surface and the second deflection surface. In this way, the sample can be illuminated using the illumination light distribution from opposite directions. This can be used to increase the contrast or to remove shading artifacts.

In one preferred embodiment, the first deflection surface and/or the second deflection surface of the first light deflection device are/is arranged outside the image field of the illumination objective.

In one particularly preferred embodiment, the light sheet microscope comprises a switchable deflection element, which is arranged in the beam path of the illumination objective and is designed to deflect the illumination light beam focused by the illumination objective in a first setting onto the first deflection surface of the first light deflection device and in a second setting onto the second deflection surface of the first light deflection device. The deflection element can be designed in particular as a tilting mirror or rocker plate. The direction from which the sample is illuminated can be changed rapidly by the deflection element. This is necessary for some light sheet-microscopy methods, in particular methods for increasing contrast or removing shading artifacts. This can be used to enhance the image quality.

In one preferred embodiment, the second light deflection device comprises a first prism, which is arranged in the beam path of the illumination objective and is designed to deflect the illumination light beam focused by the illumination objective at a right angle to the optical axis of the illumination objective. The first prism provides a mechanically simple and cost-effective way of implementing a deflection of the illumination light beam.

In a further preferred embodiment, the second light deflection device comprises a second prism, which is arranged offset to the optical axis of the illumination objective and is designed to deflect the illumination light beam focused by the illumination objective in the direction of the first deflection surface of the first light deflection device, and the second light deflection device comprises a third prism, which is arranged offset to the optical axis of the illumination objective and is designed to deflect the illumination light beam focused by the illumination objective in the direction of the second deflection surface of the first light deflection device. The two prisms provide a cost-effective way of deflecting the illumination light beam in the direction of the first or second deflection surface of the first light deflection device.

In particular, the first prism and the second prism are designed to deflect the illumination light beam focused by the illumination objective in the direction of the first deflection surface or the second deflection surface of the first light deflection device in parallel to the optical axis of the illumination objective. The deflection of the illumination light beam in parallel to the optical axis of the illumination objective is optimum with respect to the smallest possible required area of the two deflection elements and the least possible lengthening of an optical path covered by the illumination light beam. In this way, the illumination light beam is incident perpendicularly on the interface between the air and a medium enclosing the sample. In this way, the optical quality of the illumination light beam is enhanced.

In a further preferred embodiment, the second light deflection device comprises a first rhomboid prism, which is arranged offset to the optical axis of the illumination objective and is designed to offset the illumination light beam focused by the illumination objective in parallel to the optical axis of the illumination objective and to deflect it in the direction of the first deflection surface of the first light deflection device, and the second light deflection device comprises a second rhomboid prism, which is arranged offset to the optical axis of the illumination objective and is designed to offset the illumination light beam focused by the illumination objective in parallel to the optical axis of the illumination objective and to deflect it in the direction of the second deflection surface of the first light deflection device. In this embodiment, the illumination light beam is both offset in parallel to the optical axis of the illumination objective and also deflected in the direction of the first deflection surface of the first light deflection device by the first or the second rhomboid prism. In this way, complex alignment is not necessary in the manufacturing, i.e., it is not necessary to align multiple optical elements to one another in the beam path of the illumination light beam. A further advantage of this embodiment is that worsening of the optical quality of the light sheet microscope cannot occur due to drift, i.e., a shift of optical elements in the beam path of the illumination light beam in operation.

In a further preferred embodiment, the light sheet microscope comprises a beam splitter element, which is arranged in the beam path of the illumination objective and is designed to split the illumination light beam as a function of a spectral composition and/or as a function of a polarization. In particular, the beam splitter element can split the illumination light beam in such a way that a first part of the illumination light beam having a first spectral composition and/or a first polarization is guided onto the first deflection element and that a second part of the illumination light beam having a second spectral composition and/or a second polarization is guided onto the second deflection element. One advantage of the splitting as a function of the polarization is that the two light-sheet-like illumination light distributions, which propagate against one another in the sample and are possibly superimposed, do not interfere with one another if they have polarizations orthogonal to one another.

In a further preferred embodiment, the light sheet microscope comprises a polarization element, which is arranged in the beam path of the illumination objective and is designed to adjust a polarization of the illumination light beam. In conjunction with the beam splitter, which splits the illumination light beam as a function of a polarization, the polarization element can be used in particular to adjust the illumination direction. In this embodiment, a simple possibility for allocating the quantity of light of the illumination light beam between the first and the second illumination light beam is thus given in particular by a rotation of the polarization of the illumination light beam, for example by a rotatable half-wave plate in the beam path or an electro-optical modulator. The use of a particularly rapidly switching polarization element is particularly advantageous, for example a Pockels cell. The switching times of Pockels cells are between 5 and 10 kHz. The illumination direction can thus be changed with a particularly high frequency by the Pockels cell.

In a further preferred embodiment, the light sheet microscope comprises an optical element for limiting the effective numerical aperture of the illumination objective. The thickness of the light-sheet-like illumination light distribution can be controlled by the limiting of the numerical aperture of the illumination objective.

In a further preferred embodiment, the first light deflection device is rotatably arranged around the optical axis of the detection objective and/or the second light deflection device is rotatably arranged around the optical axis of the illumination objective. In this way, an illumination direction, i.e., the direction from which the sample is illuminated using the light-sheet-like illumination light distribution, can be adjusted without moving the sample itself, which can be advantageous in the case of particularly sensitive samples.

In a further preferred embodiment, the second light deflection device is arranged between the illumination objective and the sample. This is particularly advantageous if the light sheet microscope is designed as an upright microscope, i.e., if the illumination objective is arranged below the sample and the detection objective is arranged above the sample.

Alternatively thereto, the second light deflection device is arranged between the illumination objective and the first light deflection device. In other words: both light deflection devices are arranged on the illumination objective. This is particularly advantageous if the light sheet microscope is designed as an inverse microscope, i.e., if the illumination objective is arranged above the sample and the detection objective is arranged below the sample.

The light sheet microscope can be designed both as an upright and also as an inverse microscope.

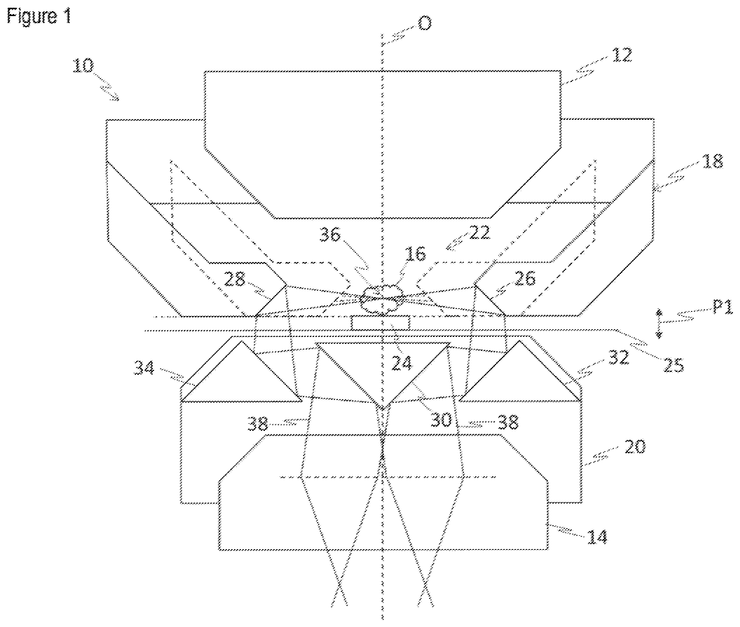

FIG. 1 shows a schematic illustration of a light sheet microscope 10 as a first exemplary embodiment. The light sheet microscope 10 comprises a detection objective 12 and an illumination objective 14, which are oriented on a sample 16. The light sheet microscope 10 furthermore comprises a first light deflection device 18 arranged on the detection objective 12 and a second light deflection device 20 arranged on the illumination objective 14.

The detection objective 12 and the illumination objective 14 are fixedly arranged opposite to one another. The optical axes of the two objectives 12, 14 are colinear, i.e., the two objectives 12, 14 have a common optical axis O. A sample chamber 22 is formed by the intermediate space between the two objectives 12, 14.

The sample 16 is arranged in the sample chamber 22 on a platform 24 and embedded in a substrate. The platform 24 is arranged on a sample carrier 25, which is designed as a cover slip in the exemplary embodiment shown. Alternatively, the sample carrier 25 can also be designed as a petri dish or microtitration plate. The sample carrier 25 is movable along the optical axis O of the two objectives 12, 14, which is indicated by a double arrow P1 in FIG. 1. An immersion medium, which is not shown for the sake of clarity in FIG. 1, is introduced between the sample carrier 25 and the detection objective 12.

The first light deflection device 18 comprises a first deflection surface 26 and a second deflection surface 28, which are arranged laterally offset to the optical axis O. The deflection surfaces 26, 28 are each inclined by 45° in the direction of the optical axis O.

The second light deflection device 20 comprises three prisms 30, 32, 34. The three prisms 30, 32, 34 each have a cross section in the form of an isosceles right triangle, wherein the surfaces of the three prisms 30, 32, 34 associated with the short sides of the triangle are mirrored. A first prism 30 is arranged in a beam path of the illumination objective 14, wherein the non-mirrored surface of the prism 30 associated with the long side of the triangle faces toward the detection objective 12. A second and a third prism 32, 34 are arranged offset to the optical axis O, wherein the non-mirrored surfaces of the prism elements 32, 34 associated with the long side of the triangle each face toward the illumination objective 14.

To illuminate a target region 36 of the sample 16, an illumination light beam 38 is generated and focused by the illumination objective 14. The target region 36 of the sample 16 is in particular a focal plane of the detection objective 12. After leaving the illumination objective 14, the illumination light beam 38 is incident on one of the two mirrored surfaces of the first prism 30 and is deflected in the direction of the second prism 32, i.e., to the right in FIG. 1. The second prism 32 guides the illumination light beam 38 in parallel to the optical axis O onto the first deflection surface 26. The deflection of the illumination light beam 38 in parallel to the optical axis O is optimal with respect to the smallest possible required area of the first deflection element 26 and the least possible lengthening of an optical path covered by the illumination light beam 38, but is not absolutely necessary. The illumination light beam 38 is deflected in the direction of the sample chamber 22, i.e., to the left in FIG. 1, and onto the sample 16 by the first deflection surface 26, whereby a light-sheet-like illumination light distribution is formed in the target region 36 of the sample 16.

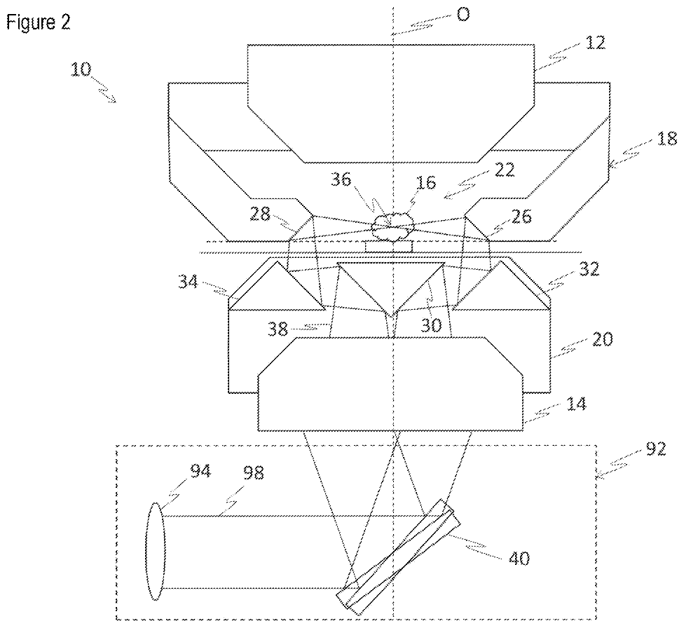

The illumination light beam 38 can be deflected by a switchable deflection element in such a way that after leaving the illumination objective 14, it is incident on another of the two mirrored surfaces of the first prism 30 and is deflected in the direction of the third prism 34, i.e., to the left in FIG. 1. The deflection element is described below on the basis of FIG. 2 and is identified there with the reference sign 40. The third prism 34 guides the illumination light beam 38 in parallel to the optical axis O onto the second deflection surface 28. The illumination light beam 38 is deflected in the direction of the sample chamber 22, i.e., to the right in FIG. 1, and onto the sample 16 by the second deflection surface 28, whereby the light-sheet-like illumination light distribution is formed in the target region 36 of the sample 16. In this way, it is possible to illuminate the sample 16 alternately from opposite directions.

FIG. 2 shows a further schematic illustration of the light sheet microscope 10 according to FIG. 1. In particular, a device 92 for generating the illumination light beam 38 is shown in FIG. 2.

The device 92 comprises a light source 94 and the switchable deflection element 40. The light source 94 generates illumination light 98, which is oriented by the deflection element 40 onto the illumination objective 14 in such a way that after passage it is incident on another of the two mirrored surfaces of the first prism 30 and is deflected in the direction of the second prism 32, i.e., to the right in FIG. 2, or of the third prism 34, i.e., to the left in FIG. 2.

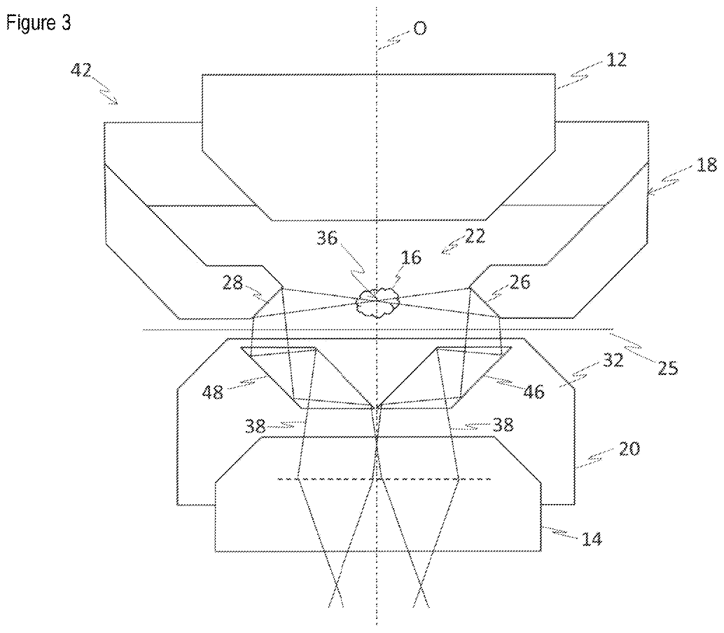

FIG. 3 shows a schematic illustration of the light sheet microscope 42 as a second exemplary embodiment. The light sheet microscope 42 according to FIG. 3 differs from the light sheet microscope 10 according to FIGS. 1 and 2 essentially in that the second light deflection device 44 of the light sheet microscope 42 according to FIG. 2 comprises two rhomboid prisms 46, 48 instead of the three prisms 30, 32, 34. Identical or identically acting elements are identified by the same reference signs in FIGS. 1 and 3.

After leaving the illumination objective 14, the illumination light beam 38 is incident in the first rhomboid prism 46. The illumination light beam 38 is guided thereby away from the optical axis O, i.e., to the right in FIG. 3, and is deflected in parallel to the optical axis in the direction of the first deflection surface 26. The illumination light beam 38 is deflected in the direction of the sample chamber 22, i.e., to the left in FIG. 3, and onto the sample 16 by the first deflection surface 26, whereby the light-sheet-like illumination light distribution is formed in the target region 36 of the sample 16.

The illumination light beam 38 can be deflected by the switchable deflection element 40 in such a way that it is incident in the second rhomboid prism 48 after leaving the illumination objective 14. The illumination light beam 38 is guided thereby away from the optical axis O, i.e., to the left in FIG. 3, and deflected in parallel to the optical axis in the direction of the second deflection surface 28. In this way, it is possible to illuminate the sample alternately from opposite directions.

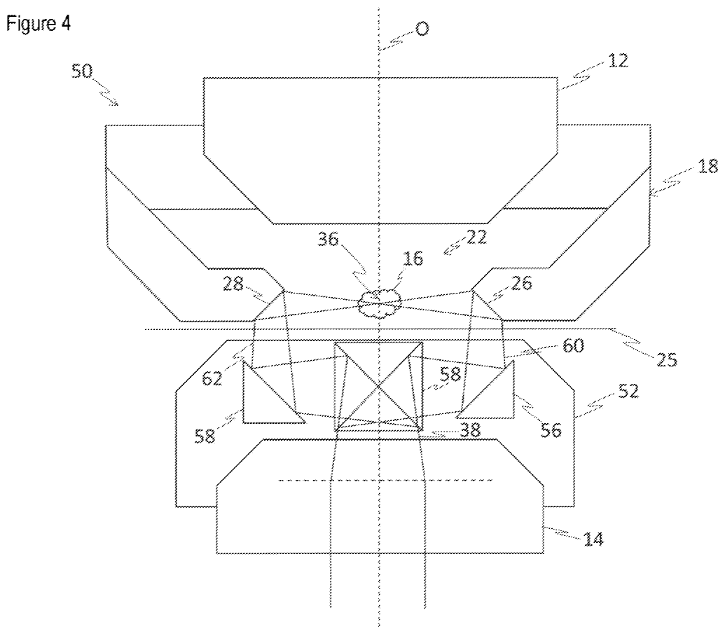

FIG. 4 shows a schematic illustration of the light sheet microscope 50 as a third exemplary embodiment. The light sheet microscope 50 according to FIG. 4 differs from the light sheet microscope 10 according to FIG. 1 essentially in that the second light deflection device 52 of the light sheet microscope 42 according to FIG. 3 comprises a beam splitter element 54 instead of the first prism 30. Identical or identically acting elements are identified by the same reference signs in FIGS. 1 and 4.

The second light deflection device 52 furthermore comprises the second and third prism 56, 58, which are arranged offset to the optical axis O. In contrast to the light sheet microscope 10 according to FIGS. 1 and 2, in each of these only the surfaces associated with the long side of the triangle are mirrored.

In an alternative exemplary embodiment, the two prisms 56, 58 of the second light deflection device 52 according to FIG. 4 replace the two prisms 32, 34 of the second light deflection device 20 according to FIGS. 1 and 2. A particularly compact construction of the second light deflection device 20 is achieved in this way.

In the exemplary embodiment shown in FIG. 4, the beam splitter element 54 is designed as a so-called X cube, which is composed of four prisms, which each have the cross-section in the form of an isosceles right triangle. The beam splitter element 54 is arranged in the beam path of the illumination objective 14 and is designed to split the illumination light beam 38 as a function of a spectral composition and/or as a function of a polarization, i.e., a first part 60 of the illumination light beam 38 is deflected to the right in FIG. 4 and a second part 62 of the illumination light beam 38 is deflected to the left in FIG. 4. This separation can take place according to spectral composition and/or polarization depending on the coating of the four prisms of the beam splitter element 54. A color-neutral splitting, in particular in equal fractions, is also conceivable. The sample 16 can be continuously illuminated on both sides in this way.

The first part 60 of the illumination light beam 38 is incident on the second prism 56 and is deflected by it in the direction of the first deflection surface 26. The second part 62 of the illumination light beam 38 is incident on the third prism 58 and is deflected by it in the direction of the second deflection surface 28.

In the exemplary embodiment shown in FIG. 4, the switchable deflection element 40 can be omitted. A control of the illumination direction, i.e., a deflection of the illumination light beam 38 in FIG. 4 to the right or left can be carried out in a simple manner by a control of the spectral composition and/or rotation of the polarization of the illumination light beam 38, for example by exchangeable and/or rotatable (spectral) filters, half-wave plates, quarter-wave plates, and/or a Pockels cell.

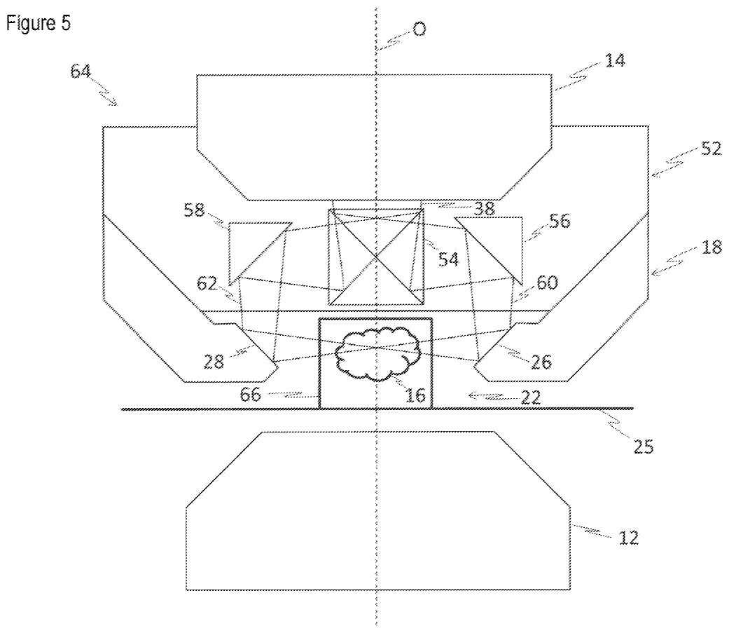

FIG. 5 shows a schematic illustration of the light sheet microscope 64 as a fourth exemplary embodiment. The light sheet microscope 64 according to FIG. 5 differs from the light sheet microscope 50 according to FIG. 4 essentially in that it is embodied as an inverse microscope, i.e., the detection objective 12 is arranged below the sample 16 and the illumination objective 14 is arranged above the sample 16. Identical or identically acting elements are identified by the same reference signs in FIGS. 1 and 5.

The light sheet microscope 64 according to FIG. 5 furthermore differs from the light sheet microscope 50 according to FIG. 4 in that the first light deflection device 18 is arranged on the second light deflection device 52, so that the second light deflection device 52 is arranged between the illumination objective 14 and the first light deflection device 18.

In the exemplary embodiment shown in FIG. 5, the sample 16 is arranged in a sample carrier 66, also called a “container”.

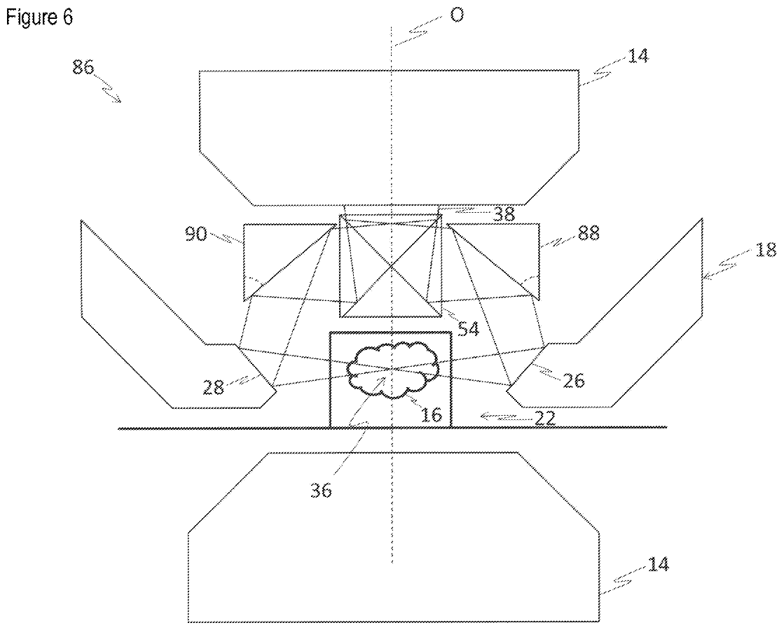

FIG. 6 shows a schematic illustration of an inverse light sheet microscope 86 as a fourth exemplary embodiment. The inverse light sheet microscope 86 according to FIG. 6 differs from the inverse light sheet microscope 64 according to FIG. 5 essentially in that the second and the third prism 88, 90 are tilted by an angle different from 45° in relation to the optical axis O, so that they deflect the illumination light beam 38 at an angle different from 90°. Identical or identically acting elements are identified by the same reference signs in FIGS. 1 and 6.

In the exemplary embodiment shown in FIG. 6, the second and the third prism 88, 90 guide the illumination light beam 38 away from the optical axis O. In other words, after leaving the second or third prism, the illumination light beam 38 does not extend in parallel to the optical axis O. In this way, the distance between the first deflection surface 26 and the second deflection surface 26 can be selected to be larger, so that the sample chamber 22 is larger.

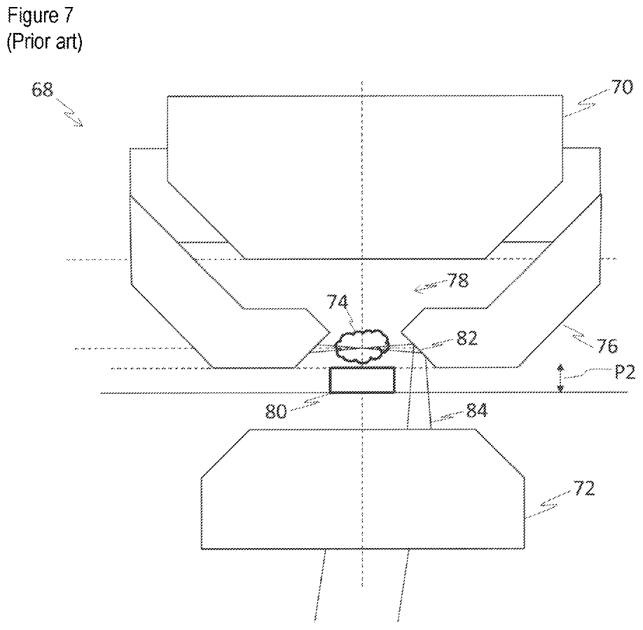

FIG. 7 shows a schematic illustration of a light sheet microscope 68 according to the prior art. The light sheet microscope 68 comprises a detection objective 70 and an illumination objective 72, which are oriented on a sample 74. The light sheet microscope 68 furthermore comprises a light deflection device 76 arranged on the detection objective 70.

The detection objective 70 and the illumination objective 72 are fixedly arranged opposite to one another. A sample chamber 78 is formed by the intermediate space between the two objectives 70, 72. The sample 74 is arranged on a platform 80 in the sample chamber 78. The platform 80 is movable, which is indicated by a double arrow P2 in FIG. 7.

The light deflection device 76 comprises a deflection surface 82, which is arranged laterally offset to the optical axis O and is inclined by 45° in the direction of the optical axis O.

To illuminate the sample 74, an illumination light beam 84 is generated and focused by the illumination objective 72. After leaving the illumination objective 14, the illumination light beam 84 is incident on the deflection surface 82 of the light deflection device 76. The illumination light beam 84 is deflected in the direction of the sample chamber 78, i.e., to the left in FIG. 7, and onto the sample 74 by the first deflection surface 82, whereby a light-sheet-like illumination light distribution is formed in the sample 74.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 light sheet microscope
12 detection objective
14 illumination objective
16 Sample
18, 20 light deflection device
22 sample chamber
24 Platform
26, 28 deflection surface
30, 32, 34 Prism
36 target region
38 illumination light beam
40 deflection element
42 light sheet microscope
44 light deflection device
46, 48 rhomboid prism
50 light sheet microscope
52 light deflection device
54 beam splitter element
56, 58 Prism
60, 62 Part
64 light sheet microscope
66 sample carrier
68 light sheet microscope
70 detection objective
72 illumination objective
74 Sample
76 light deflection device
78 sample chamber
80 Platform
82 deflection surface
84 illumination light beam
86 light sheet microscope
88, 90 Prism
92 Device
94 light source
98 illumination light
O optical axis
P1, P2 double arrow

1. A light sheet microscope, comprising:
a detection objective configured to image a target region of a sample located in a focal plane of the detection objective;
an illumination objective configured to focus an illumination light beam in the sample,
the detection objective and the illumination objective are being opposite to one another, and the optical axis of the detection objective and the optical axis of the illumination objective being parallel to one another;
a first light deflection device having at least one first deflection surface and one second deflection surface, which are each arranged offset to the optical axis of the detection objective and are configured to deflect the illumination light beam focused by the illumination objective in a direction perpendicular to the optical axis of the detection objective such that a deflected illumination light beam forms a light-sheet-like illumination light distribution focused in the focal plane; and
a second light deflection device configured to deflect the illumination light beam focused by the illumination objective on at least one of the two deflection surfaces of the first light deflection device.

2. The light sheet microscope of claim 1, wherein the second light deflection device is arranged between the illumination objective and the first light deflection device.

3. The light sheet microscope of claim 1, wherein the optical axis of the detection objective is arranged between the first deflection surface and the second deflection surface.

4. The light sheet microscope of claim 1, wherein the second light deflection device is configured to offset the illumination light beam focused by the illumination objective in parallel to the optical axis of the illumination objective.

5. The light sheet microscope of claim 1, wherein the first deflection surface and/or the second deflection surface of the first light deflection device are/is arranged outside an image field of the illumination objective.

6. The light sheet microscope of claim 1, further comprising:
a switchable deflection element arranged in a beam path of the illumination objective and is configured to deflect the illumination light beam focused by the illumination objective on the first deflection surface of the first light deflection device in a first setting and on the second deflection surface of the first light deflection device in a second setting.

7. The light sheet microscope of claim 1, wherein the second light deflection device comprises a first prism, which is arranged in a beam path of the illumination objective and is configured to deflect the illumination light beam focused by the illumination objective at a right angle to the optical axis of the illumination objective.

8. The light sheet microscope of claim 7, wherein the second light deflection device comprises a second prism, which is arranged offset to the optical axis of the illumination objective and is configured to deflect the illumination light beam focused by the illumination objective in a direction of the first deflection surface of the first light deflection device, and
wherein the second light deflection device comprises a third prism, which is arranged offset to the optical axis of the illumination objective and is configured to deflect the illumination light beam focused by the illumination objective in a direction of the second deflection surface of the first light deflection device.

9. The light sheet microscope of claim 1, wherein the second light deflection device comprises a first rhomboid prism, which is arranged offset to the optical axis of the illumination objective and is configured to offset the illumination light beam focused by the illumination objective in parallel to the optical axis of the illumination objective and to deflect the illumination light beam in a direction of the first deflection surface of the first light deflection device, and
wherein the second light deflection device comprises a second rhomboid prism, which is arranged offset to the optical axis of the illumination objective and is configured to offset the illumination light beam focused by the illumination objective in parallel to the optical axis of the illumination objective and to deflect the illumination light beam in a direction of the second deflection surface of the first light deflection device.

10. The light sheet microscope of claim 1, further comprising:
a beam splitter element, which is arranged in a beam path of the illumination objective and is configured to split the illumination light beam as a function of a spectral composition and/or as a function of a polarization.

11. The light sheet microscope of claim 1, further comprising:
a polarization element, which is arranged in a beam path of the illumination objective and is configured to adjust a polarization of the illumination light beam.

12. The light sheet microscope of claim 1, further comprising:
an optical element configured to limit an effective numerical aperture of the illumination objective.

13. The light sheet microscope of claim 1, wherein the first light deflection device is rotatably arranged around the optical axis of the detection objective and/or the second light deflection device is rotatably arranged around the optical axis of the illumination objective.

14. The light sheet microscope of claim 1, wherein the second light deflection device is arranged between the illumination objective and the sample.
